(19) United States
(12) Patent Application Publication
(10) Pub. No.: US 2014/0137638 A1
(43) Pub. Date: May 22, 2014

(54) FLEXIBLE BLADE RHEOMETER

(71) Applicants: Alexander Liberzon, Natania (IL); Roi Gurka, Kiryat-Bialik (IL)

(72) Inventors: Alexander Liberzon, Natania (IL); Roi Gurka, Kiryat-Bialik (IL)

(73) Assignee: Ramot at Tel-Aviv University Ltd., Tel-Aviv (IL)

(21) Appl. No.: 14/129,972

(22) PCT Filed: Jun. 28, 2012
(86) PCT No.: PCT/IL2012/050225

§ 371 Date: Dec. 29, 2013

Related U.S. Application Data
(60) Provisional application No. 61/502,366, filed on Jun. 29, 2011.

(51) Int. Cl. G01N 11/14

(52) U.S. Cl. CPC G01N 11/14
USPC 73/54.28

(57) ABSTRACT

A rheometer including a flexible blade, a unit for measuring flex of at least part of the blade, a computation unit configured for converting input of parameters from the measurement unit to output of viscosity measurement. A method for determining viscosity including rotating a flexible blade in a medium whose viscosity is being measured, measuring blade flex of at least part of the blade, converting the blade flex measurement to a viscosity measurement, and producing output of determined viscosity. Related apparatus and methods are also described.

### RELATED APPLICATION/S

This application claims priority from U.S. Provisional Patent Application No. 61/502,366 filed 29 Jun. 2011. The contents of the above application are incorporated by reference as if fully set forth herein.

### FIELD AND BACKGROUND OF THE INVENTION

The present invention, in some embodiments thereof, relates to a rheometer, and, more particularly, but not exclusively, to a rheometer with a flexible blade.

Process design, product consistency, and consumer experience are all affected by fluid viscosity. Thus, various industries evaluate effective viscosity as a simple process and quality control indicator (Chen et al., 2010, Steffe 1996). Viscosity is typically affected by temperature and a fluid's internal structure, which can change under applied shear. High shear rates are typically required to evaluate water-scale viscosity, as sensitivity of many existing viscometers and rheometers is inadequate for low-viscosity samples In the case of dilute polymer solutions, high shear rate can degrade molecules or formed microstructures (Minoura et al., 1967).

Different approaches exist to measure the viscosity of a fluid by direct or indirect measurement. Rheometers use a direct approach, where either torque or strain is applied to a sample and a response strain or torque is measured (Steffe 1996 p. 3). In such types of instruments, viscosity can be calculated through fluid constitutive equations (Steffe 1996 p. 33). Some instruments rely on measuring a fluid speed (e.g.: Noel et al., 2011) or a force applied to mixing blades (e.g.: Rice et al., 2006), where higher viscosity increases resistance to flow, through friction. Some common viscometers estimate the time it takes a fluid to pass a known distance (Ostwald viscometer) or the time it takes for a mechanical probe, such as ball (Falling ball viscometer), piston (Falling piston viscometer), or cylinder (Rotational Couette viscometer) to move through an initially stationary fluid (see review of Barnes and Nguyen, 2001, among others).

Accurate measurements of viscosity, especially of dilute solutions is an obstacle in processing industries such as chemical, food, pharmaceutical, as well as an ubiquitous task in research laboratories worldwide. Dilute solutions cause only slight changes in viscosity relative to a solvent's viscosity. To date there are no high-accuracy cost-effective solutions, such as available for very viscous fluids and/or for low-accuracy measurements.

Present viscosity measurement typically use one of: i) torque measurement; ii) flow through small vessels; and iii) optical assessment of fluid drop formation. These measurements require high precision mechanics, optics and/or electronics, which drive up the cost of measurement.

There are two different types of rheometers: shear and extensional rheometers. Shear rheometers control the applied shear stress or shear strain. Extensional rheometers apply extensional stress or extensional strain.

Example types of shear rheometers:

Pipe or capillary rheometers—based on forming laminar flow conditions and a known ratio between pressure drop and shear stress.

A rotational cylinder and a double concentric cylinder—liquid is placed within an annulus cylinder. One of the cylinders is rotated at a constant speed. The rotation determines a shear rate inside an annulus. The liquid tends to drag the other cylinder round, and the torque it exerts on the cylinders is measured.

Cone and plate—Liquid is placed on a horizontal plate and a shallow cone placed into the liquid. An angle between the surface of the cone and the plate is typically of the order of 1 degree. Typically the plate is rotated and force on the cone measured.

Example extensional rheometers:

Rheotens—a fiber spinning rheometer, suitable for polymeric melts. Material is pumped from an upstream tube, and a set of wheels elongates a strand. A force transducer mounted on a wheel measures a resultant extensional force.

CaBER—a capillary breakup rheometer. A small quantity of material is placed between plates, which are rapidly stretched to a fixed level of strain. A midpoint diameter is measured as a function of time as a fluid filament necks and breaks up under combined forces of surface tension, gravity, and viscoelasticity.

FiSER (Filament Stretching Extensional Rheometer)—a set of linear motors drive a fluid filament apart at an exponentially increasing velocity while measuring force and diameter as a function of time and position. By deforming at an exponentially increasing rate, a constant strain rate can be achieved in samples.

Sentmanat—A film of polymer is wound on two rotating drums, which apply constant or variable strain rate extensional deformation on the polymer film. Stress is determined from torque exerted by the drums.

Acoustic rheometers employ a piezo-electric crystal that can launch a wave of extensions and contractions into a fluid. The acoustic rheometer applies an oscillating extensional stress. Acoustic rheometers measure the speed of sound and attenuation of ultrasound for a set of frequencies. The speed of sound is a measure of system elasticity. A measurement of the speed of sound can be converted into fluid compressibility. Attenuation is a measure of viscous properties.

Capillary/Contraction Flow—involve liquid going through an orifice, expanding from a capillary, or sucked up from a surface into a column by a vacuum.

Comments regarding extensional rheometers:

Interactions of a test fluid with solid interfaces result in a component of shear flow, which compromises measurement results. A strain history of material elements in the extensional should be known and controlled. Strain rates and strain levels should be high enough to stretch polymeric chains beyond their normal radius of gyration, requiring instrumentation with a large range of deformation rates and a large travel distance. Commercially available extensional rheometers are typically segregated according to their applicability to viscosity ranges.

Additional background includes:
Z. J. Taylor, Gurka, R., Kopp, G. A., Liberzon, A., Long-duration time-resolved PIV to study unsteady aerodynamics, IEEE Trans. Instrum. Meas. 59, 3262 (2011).
D. T. N. Chen, Wen, Q., Janmey, P. A., Crocker, J. C. and Yodh, A. G., Rheology of Soft Materials, Annu. Rev. Cond. Mat. Phys. 1, 301 (2010).
J. F. Steffe, Rheological Methods in Food Process Engineering, 2^{nd} Ed., Freeman Press, USA (1996) p. 3.
Y. Minoura, Kasuya, T., Kawamura, S. and Nakano, A., Degradation of Poly(ethylene Oxide) by High-speed Stirring, J. Polymer Sci., 5, 125 (1967).
M. H. Noël, Semin, B., Hulin, J. P. and Auradou, H., Viscometer using drag force measurements, Rev. Sci. Inst., 82, 023909 (2011).
M. Rice, Hall, J., Papadakis, G. and Yianneskis, M., Investigation of laminar flow in a stirred vessel at low Reynolds numbers, Chem. Eng. Sci. 61, 2762 (2006).
H. A. Barnes, and Nguyen, Q. D., Rotating vane rheometry—a review, J. Non-Newtonian Fluid Mech. 98, 1 (2001).
N. D. Sylvester and Tyler, J. S. “Dilute Solution Properties of Drag Reducing Polymers” Technical report THEMIS-UND-70-8, University of Notre Dame, (1970).
O. Cadot, Bonn, D., Douady, S., Turbulent drag reduction in a closed system: boundary layer versus bulk effects, Phys. Fluids 10(5), 426-436, 1998.

The disclosures of all references mentioned above and throughout the present specification, as well as the disclosures of all references mentioned in those references, are hereby incorporated herein by reference.

### SUMMARY OF THE INVENTION

The present invention, in some embodiments thereof, measures viscosity of a medium by measuring flex of a blade caused by pressure of the medium against the blade.

In some embodiments the blade is flexible, and bends, or flexes, while the blades moves in the medium.

In some embodiments, the blade rotates in the medium.

In some embodiments, the fluid is moved against the blade.

The term “flex” in all its grammatical forms is used throughout the present specification and claims to mean to bend and or to be deformed, usually, yet not exclusively, returning to an original shape when a flexing force is not exerted any more.

The term “blade” in all its grammatical forms is used throughout the present specification and claims to describe an object which flexes in response to the medium moving relative to the object. In some embodiments the blade may be a cantilever, a rod, a plate, a wing, and so on.

In some embodiments, flex of the blade is measured, and used to calculate viscosity.

In some embodiments stress of the blade is measured, and used in determining blade flex. In some embodiments deformation of the blade is measured, and used in determining blade flex.

In some embodiments, a flow field of the medium around the blade is determined, and used in determining viscosity.

According to an aspect of some embodiments of the present invention there is provided a rheometer including a flexible blade, a unit for measuring flex of at least part of the blade, a computation unit configured for converting input of parameters from the measurement unit to output of viscosity measurement.

According to some embodiments of the invention, further including an imaging measurement unit, positioned to image the blade-medium interaction, at least some of the time, wherein the computation unit is also configured to use input from the imaging measurement unit for the converting to output of viscosity measurement.

According to some embodiments of the invention, the imaging unit measures blade flex. According to some embodiments of the invention, the blade flex is measured by measuring blade strain. According to some embodiments of the invention, the imaging measurement unit estimates fluid flow.

According to some embodiments of the invention, the computation unit includes a Look Up Table (LUT) including data corresponding to data from the measurement units to use in the converting to output of viscosity measurement.

According to some embodiments of the invention, configured to be in-line to a flow of a medium whose viscosity is to be measured.

According to some embodiments of the invention, further including a torque measurement unit for measuring torque exerted on the blade.

According to some embodiments of the invention, the flexible blade is attached to a rotational shaft, which rotates the flexible blade in a medium whose viscosity is being measured.

According to some embodiments of the invention, the torque measurement unit is configured to measure torque applied to the rotational shaft.

According to some embodiments of the invention, the flexible blade is attached to a rotational shaft, which rotates the flexible blade in a medium whose viscosity is being measured, and further including a rotational speed measurement unit for measuring rotational speed of the blade.

According to some embodiments of the invention, further including a shear measurement unit, the shear measurement unit measuring shear in a medium whose viscosity is being measured.

According to some embodiments of the invention, further including a unit configured to measure deflection of a tip of the blade while the blade is rotating.

According to some embodiments of the invention, the unit configured to measure deflection of the tip of the blade includes a camera for capturing images of the blade.

According to some embodiments of the invention, further including a unit configured to image a flow velocity field in a medium whose viscosity is being measured.

According to some embodiments of the invention, the computation unit accepts input data including at least one parameter from the group which includes a medium identifier, a height of the medium within a container in which the blade is configured to rotate, an approximation of an initial value of viscosity of the medium, an approximation of an initial value of dilution of a second material within the medium, a blade identifier, parameters describing the blade geometry, one or more parameters describing blade thickness, blade Young modulus, and parameters describing the container geometry.

According to some embodiments of the invention, the computation unit provides output of deviations from a semi-analytical model.

According to some embodiments of the invention, the computation unit includes a unit configured to calculate a model-based value of viscosity, and the LUT provides deviations from the model-based value of viscosity.

According to some embodiments of the invention, further comprising a plurality of flexible blades.

According to an aspect of some embodiments of the present invention there is provided a method for determining viscosity including rotating a flexible blade in a medium whose viscosity is being measured, measuring blade flex of at least part of the blade, converting the blade flex measurement to a viscosity measurement, and producing output of determined viscosity.

According to some embodiments of the invention, further including imaging blade-medium interaction, and using input from the imaging for the producing output of determined viscosity. According to some embodiments of the invention, the imaging measures blade flex.

According to some embodiments of the invention, further including calibration of blade flex to viscosity using a medium of known viscosity. According to some embodiments of the invention, the calibration is performed for a specific blade. According to some embodiments of the invention, the calibration is performed for a specific vessel containing the medium.

According to some embodiments of the invention, the flexible blade is selected based, at least in part, on an expected value of viscosity to be measured. According to some embodiments of the invention, a shape of a vessel for containing the medium is selected based, at least in part, on an expected value of viscosity to be measured.

According to some embodiments of the invention, the blade flex is measured by measuring blade strain.

According to some embodiments of the invention, the imaging estimates fluid flow.

According to some embodiments of the invention, the converting includes converting input of physical parameters of the measuring blade flex and the imaging to output of viscosity measurement. According to some embodiments of the invention, the converting uses a Look Up Table (LUT) for the converting.

According to some embodiments of the invention, further including measuring torque on a shaft rotating the flexible blade, and further including inputting a torque measurement to the LUT.

According to some embodiments of the invention, further including measuring shear and further including inputting a shear measurement to the LUT.

According to some embodiments of the invention, further including measuring shear and further including refraining from producing output of determined viscosity when a value of measured shear is higher than a threshold value.

According to some embodiments of the invention, further including measuring shear and further including alerting a user that output of determined viscosity may be unreliable when a value of measured shear is higher than a threshold value.

According to some embodiments of the invention, further including measuring shear and further including using a value of measured shear in order to produce the output of determined viscosity.

According to some embodiments of the invention, further including measuring deflection of a tip of the blade while the blade is rotating, and further including inputting a blade tip deflection to the LUT.

According to some embodiments of the invention, the measuring deflection of the tip of the blade includes capturing an image of the blade while the blade is rotating, and measuring the deflection based, at least in part, on analyzing the image.

According to some embodiments of the invention, further including imaging a flow velocity field in the medium whose viscosity is being measured.

According to some embodiments of the invention, further including inputting data to the LUT including at least one physical parameter from the group which includes a medium identifier, a height of the medium within a container in which the blade is configured to rotate, an approximation of an initial value of viscosity of the medium, an approximation of an initial value of dilution of a second material within the medium, a blade identifier, parameters describing the blade geometry, one or more parameters describing blade thickness, blade Young modulus, and parameters describing the container geometry.

According to some embodiments of the invention, the LUT includes deviations of viscosity from an analytical model of viscosity. According to some embodiments of the invention, the LUT includes deviations of viscosity from a semi-analytical model of viscosity.

According to some embodiments of the invention, the rotating, the measuring, the converting and the producing are performed continuously.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

### BRIEF DESCRIPTION OF THE DRAWINGS

Some embodiments of the invention are herein described, by way of example only, with reference to the accompanying drawings and images. With specific reference now to the drawings and images in detail, it is stressed that the particulars shown are by way of example and for purposes of illustrative discussion of embodiments of the invention. In this regard, the description taken with the drawings and images makes apparent to those skilled in the art how embodiments of the invention may be practiced.

In the drawings:

FIG. 1A is a photo of a flexible blade rheometer constructed according to an example embodiment of the invention;

FIG. 1B is a simplified illustration of a flexible blade rheometer constructed according to an example embodiment of the invention;

FIG. 1C is a simplified illustration of a flexible blade rheometer constructed according to an example embodiment of the invention;

FIGS. 1D, 1E and 1F are photographs of components of a flexible blade rheometer constructed according to an example embodiment of the invention;

FIG. 2 is a bottom-up photograph of a flexible blade of the flexible blade rheometer constructed according to an example embodiment of the invention;

FIG. 3A is a graphic illustration of tangential velocity distributions of flow along a radius of a flexible blade of a flexible blade rheometer constructed according to an example embodiment of the invention;

FIG. 3B is a graphical illustration of a solution of a semi-analytical model of deflection of a flexible blade of a flexible blade rheometer constructed according to an example embodiment of the invention;

FIG. 3C is a graphical illustration of two-dimensional velocity fields in a vessel at four rotational rates of a flexible blade rheometer constructed according to an example embodiment of the invention;

FIG. 3D is a graphical illustration of strain measured on a flexible blade rheometer constructed according to an example embodiment of the invention;

FIG. 4 is a simplified illustration of a real time monitoring device including a flexible blade rheometer constructed according to an example embodiment of the invention;

FIG. 5 is a graphical representation presented in “Dilute Solution Properties of Drag Reducing Polymers, by Sylvester N. D. and Tyler, J. S. Technical report THEMIS-UND-70-8, University of Notre Dame, 1970”;

FIG. 6 is a graphical representation of shear viscosity measurements of the drag-reducing solution of 30 wppm polymer polyox, presented in “Cadot, Bonn, Douady, Phys. Fluids 10(5), 426-436, 1998;

FIG. 7 is a bottom view photograph of a flexible blade rheometer; and

FIG. 8 is a simplified flow chart illustration of a method for determining viscosity according to an example embodiment of the invention.

### DESCRIPTION OF SPECIFIC EMBODIMENTS OF THE INVENTION

The present invention, in some embodiments thereof, relates to a rheometer, and, more particularly, but not exclusively, to a rheometer with a flexible blade.

In some embodiments the rheometer measures variations caused by small alteration of friction on liquid-solid boundaries of the rotational rheometer.

An example embodiment which is used herein is an embodiment in which the blade is flexible, and flexes while the blade moves in the medium. The example embodiment is used to illustrate principles, and is not to be taken as limiting to the example only.

### INTRODUCTION

The present invention, in some embodiments thereof, measures flex of a flexible blade as a result of fluid exerting force on the blade, and the measure is used as a basis for determining viscosity.

The present invention, in some embodiments thereof, measures viscosity of a medium using a blade rotating relative to the medium.

In some embodiments the blade is flexible, and bends, or flexes, while rotating relative to the medium.

A Rheometer

The rheometer, in example embodiments thereof, is optionally used to measure viscosity in many types of fluids, implying a large range of viscosities and physical features (e.g. corrosiveness, extreme heat, poison fumes requiring a closed vessel, and so on).

In some embodiments, viscosity is determined, as described below, based on knowing the physical conditions under which measurements were made, such as vessel type and geometry, blade type and geometry, fluid flow, blade rotational rate, flex measured, and so on.

In some embodiments, one or more of the physical conditions under which measurements were made are controlled, that is, a vessel with suitable properties and dimensions is selected; a blade with suitable properties and dimensions is selected (including blade dimensions relative to vessel dimension, which potentially define size of the gap between blade edge and vessel wall); amount of fluid in the vessel; height of fluid in the vessel and/or relative to the blade; flow speed of the fluid; rotational rate and/or torque of a rotating blade; and so on.

In some embodiments, calibration of the rheometer is performed. For example, calibration is optionally performed using a vessel and blade selected to suit a specific fluid, group of fluids, or working conditions, by using a viscosity standard and the vessel and blade to calibrate the rheometer for a specific range of viscosities and fluids.

Flex

Different ways to measure flex of the flexible blade are taught, and may be used separately or in conjunction, each providing a flex measure and/or corroborating each other's measure.

In some embodiments flex is determined by a stress gauge attached to or built into the flexible blade. The stress gauge provides a measure of stress of the blade, which corresponds to flex of the blade.

In some embodiments flex is determined by more than one stress gauge attached along the flexible blade, measuring stress at different locations along the blade. In some embodiments the different stress measurements are averaged. In some embodiments the different stress measurements are each used as entry values in a look up table (LUT).

In some embodiments flex is determined by imaging the flexible blade during interaction with a fluid, and measuring deformation of the blade in the image, which corresponds to flex of the blade.

In some embodiments flex is determined by illuminating the flexible blade with a laser beam, during interaction with a fluid, and measuring deflection of the laser beam, which corresponds to deformation of the blade, which corresponds to flex of the blade.

In some embodiments a laser source is built into a tip of the blade, and flex of the blade is optionally determined by a change in where a laser beam from a flexed blade illuminates relative to where a laser beam from an un-flexed blade illuminates.

In some embodiments, the blade is only partially immersed in the fluid, yet the flex of the blade is measured and determines viscosity. One non-limiting example is a case of molten metal, or corrosive material, where a stress gauge may not operate, and/or the fluid is not transparent enough for optical imaging of blade flex. The blade is optionally mostly immersed, optionally flexing in an amount which is determined by the flex of the blade emerging above the fluid.

In some embodiments the blade and/or velocity of the fluid is controlled so that blade flex is in a range which is a linear range with respect to the measuring method, for example linear strain measurement and/or linear optical deflection measurement.

In some embodiments, analytical and/or semi-analytical models of flex are optionally worked out according to engineering calculation of cantilever bending under stress.

Blade Material

In some embodiments the blade is made of a material selected so as to withstand stresses applied to the blade and/or the viscosity measurement environment.

In some embodiments the material is flexible under expected stresses.

In some embodiments the material is springy under expected stresses, returning to its original shape when stress is no longer applied.

In some embodiments the material deforms substantially linearly under expected stresses.

In some embodiments geometry of the blade, such as thickness, length, width, shape (for example fixed thickness or tapering) is controlled so that blade flex is in a range which is a linear range with respect to the measuring method.

In some embodiments, the blade is selected or constructed so as to withstand expected fluid temperatures and/or expected fluid corrosivity.

In some embodiments the blade is produced of a composite material.

In some embodiments the blade includes piezo-electric material, so that deflection of the blade may optionally be determined by measuring an electric signal generated by the blade deflecting.

In some embodiments, for example as embodiments in which blade deflection is determined optically, blade color is optionally selected to provide contrast with a color of the medium to be measured and/or with the vessel.

Optionally Using a Look Up Table (LUT)

One way of using measures of stress to determine viscosity, is optionally pre-calibrating a rheometer using solutions with known viscosities. The flexible blades of the rheometer are optionally rotated within the fluid of known viscosity, and stress is measured, optionally with additional measures. Optionally, a LUT of flex VS viscosity is prepared.

In some embodiments, the LUT includes additional parameter combinations, such as, by way of some non-limiting examples:

flex, blade rotation velocity, viscosity;

flex, angular acceleration, viscosity;

flex, rotational torque, viscosity;

flex, rotational acceleration, time from start of acceleration, viscosity;

while the above have been combinations of three example physical parameters of a rheometer/fluid setup, combinations of physical parameters are envisaged, correlating blade flex to viscosity.

Blade Rotation Velocity

In some embodiments, an imaging unit is used to image the blade and/or the fluid in the rheometer and used to estimate blade rotation velocity. It is noted that in embodiments using an imaging unit to measuring deformation of the blade, the imaging unit may optionally be used to also estimate blade rotation velocity.

In some embodiments, speed of rotation of a shaft used to rotate the blades is used to measure blade rotation velocity.

Analytical and Semi-Analytical Models

In some embodiments, an analytical or a semi-analytical model may be used to model interaction between fluid viscosity and blade flex. Optionally, additional parameters are used in the models, such as blade geometry, physical properties of the blades, rotation velocity, fluid chamber dimensions, gap between blade tips and sides of the fluid chamber, gap between the blade and a bottom of the fluid chamber, and so on. In such embodiments data is optionally entered describing a measurement setup, including a blade flex determination, and viscosity is optionally estimated based, at least in part, on the model.

It is noted that mixing blade rheometers probe resistance of a fluid to flow. Unlike some rheometers where shear rate throughout the rheometer is known, the shear rate around a blade is complex and may be hard to impossible to model analytically, so a semi-analytic model may optionally be used. In some embodiments, empirical relations are utilized in transport equations and pre-measured boundary conditions are applied to fluid transport equations, making up a semi-analytical model so that a viscosity measurement is obtained.

A LUT Describing Deviations from a Model

In some embodiments, an analytical or a semi-analytical model may be used to model interaction between fluid viscosity and blade flex. The model is optionally used to determine expected measurements at different rheometer/fluid measurement setups, and optionally prepare a table of the expected measurements. A LUT is then optionally prepared by pre-calibrating the rheometer using solutions with known viscosities, similarly to preparing the LUT described above, optionally containing differences between model-expected viscosity values and known viscosity values.

Optional Dynamic Measurements

In some embodiments a dynamic (time dependent) collection of one or more of fluid speed; rotational rate; rotational torque; deflection; stress; temperature; and other measured physical parameters is made. In some fluids, development of shear and/or torque may affect their viscosity, causing shear thinning or shear thickening. In some embodiments of the invention measurement conditions are tracked and/or controlled, to avoid shear thinning or shear thickening, or to detect when shear thinning or shear thickening has occurred.

Rotating a Blade in a Fixed Vessel, and/or Rotating a Vessel with a Fixed Blade

In some embodiments the blade is rotated within the medium, the flex of the blade is measured, and the flex is optionally used to determine viscosity of the medium.

In some embodiments the medium is rotated around the blade, the flex of the blade is measured, and the flex is optionally used to determine viscosity of the medium.

Flowing a Fluid Past a Fixed Blade

In some embodiments fluid flows past a blade in a vessel or a pipe. The blade optionally flexes as a result of the fluid flowing past the blade. Flex of the blade is optionally measured, and viscosity of the fluid is optionally determined.

In-Line Measurement VS Sample Measurement

In some embodiments viscosity measurement is performed on a fluid sample placed in a vessel, using a flex-blade rheometer.

In some embodiments viscosity measurement is performed in-line, on a fluid in a vessel or even in a pipe which is part of a system in which the fluid flows, using a flex-blade rheometer placed in the vessel or pipe.

Obtaining a Fluid Flow Field

In some embodiments, a fluid flow field is obtained, optionally by imaging the fluid.

In some embodiments, a fluid flow (velocity) field is obtained by using imaging methods such as particle tracking, and/or using imaging velocimetry methods.

In some embodiments, shear in the fluid, defined as a derivative of the velocity of the fluid flow, is determined, for example using Particle Image Velocimetry (PIV), for example as described in above-mentioned Taylor et al (2011).

In some fluids, such as non-Newtonian fluids, shear thinning fluids, or shear thickening fluids, flex of a blade may not be linearly proportional to viscosity of the fluid. The flex may depend on conditions in the fluid.

In some embodiments, an amplitude of shear, and optionally location of shear, is measured. Optionally, if amplitude of shear is determined to be higher than a threshold level, and/or if location of high shear is determined to be at a significant location, such as, by way of a non-limiting example, adjoining the blade, the shear is taken into account when determining viscosity.

In some embodiments, a different LUT, or a different row in a LUT, is used for the same liquid under low shear conditions than under high shear conditions.

In some embodiments, a different LUT, or a different row in a LUT, is used when shear is detected at different locations relative to a blade and/or to a vessel.

In some embodiments, detecting shear according to the above conditions optionally rules out determining viscosity by measuring blade flex.

In some embodiments, detecting shear according to the above conditions optionally causes the rheometer to indicate shear problems, in order that a user may restart viscosity measurement, optionally avoiding shear problems by using a lower rotation rate and/or lower fluid flow rate, and so on.

A General Description of Some Example Embodiments

In some embodiments the rheometer measures viscosity of very dilute solutions with high accuracy using a cost-effective and simple method.

In some embodiments the method uses an interaction between fluid and a flexible blade, which is forced to rotate at a constant and/or a variable speed in a vessel with a dilute solution.

Properties of fluid flow developed in a vessel are generally not solved analytically, as the properties depend on a strong coupling between boundary layers on sides of the vessel and a boundary layer developed on the blade. The coupling depends on shear-strain properties of the liquid, and one or more of the known properties of the mechanical system, such as: mechanical and structural properties of the flexible blades, rotational speed, torque on the shaft and the position of the blade in the vessel, such as a gap between the blades and the bottom and/or side walls of the vessel.

In some embodiments, operation of the rheometer includes pre-calibration using liquid samples of known viscosity. Parameters measured during the calibration are optionally stored as a look-up table (LUT), enabling rapid assessment of viscosity of a sample during the measurement. The LUT is based on one or more of: i) torque measured using a strain-gauge and/or voltage/current measurements through a DC motor providing the torque; ii) rotational speed; iii) deflection and/or strain of the blade.

In some embodiments the LUT is optionally produced in conjunction with a semi-analytical model solved numerically in conjunction with the experimental results. Measured deviations from a modeled solution optionally provide calibration parameters related to possible mechanical losses in a given rheometer apparatus, and/or to undesired high-order fluid-structure interaction modes, and so on.

In some embodiments, the semi-analytical model is optionally solved in real-time when a measurement is taken, to provide a user with a real-time model of a strain-stress curve of the liquid under test.

In some embodiments, a fluid flow velocity field is optionally measured. A shape of boundary layers at the side walls and on the flexible blade is optionally measured, and provides data which can potentially provide a shear-thickening or shear-thinning behavior of the fluid in less measurement runs, replacing repetitive measurements at different rotational speeds.

In some embodiments, boundary layer velocity and/or shear profile are used to deduce empirical relations and parameters to be included in the semi-analytical model.

In some embodiments, viscosity of a given fluid is calculated, based on flexing of an immersed rotating flexible blade causing motion of a fluid in a tank surrounding it. In some embodiments the calculation relies on an ability to determine a deflection of the blade as the blade moves against the fluid. Sensitivity of the measurement is optionally controlled by changing system geometry and/or blade mechanics. In some embodiments measurements are optionally performed during in-line processing.

In some embodiments the rheometer measures viscosity in low viscosity fluids.

In some embodiments viscosity is determined by rotating a flexible blade within a cylindrical vessel.

In some embodiments viscosity is determined by rotating a flexible blade while maintaining a constant angular velocity within a cylindrical vessel. As the blade rotates a torque transducer optionally measures strain or deflection of the flexible blade. The deflection during rotation is proportional to the sample viscosity.

Measurements in standard materials are described, teaching that blade strain monotonically increases with rotational speed, and that strain amplitude increases with viscosity. Measurements described herein are relatively rapid, by way of a non-limiting example, taking from less than one second, to 1 second, 10 seconds, 30 seconds, and more.

Time for determining viscosity is related to how much time it takes for a blade to react to fluid viscosity.

In some embodiments, for example an embodiment using a rotating blade, viscosity is determined before a blade has completed one rotation, and even before the blade has completed a quarter of a rotation.

In some embodiments, a longer time is used to determine fluid viscosity, optionally determining many estimates, optionally averaging the estimates to achieve higher accuracy, optionally determining a curve describing the estimates, and analyzing the curve to determine a viscosity estimate.

Embodiments of the invention have a potential for use for simple, fast, and inexpensive in-line viscosity measurements.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In some embodiments, the blade used in a rotational blade rheometer is a flexible rather than a stiff blade. The flexible blade potentially reacts to small changes in viscosity, and the reaction may be measured. Measurement of the blade's reaction to small changes in viscosity, as described herein. enable a cost effective measurement of the small changes.

In some embodiments, multiple blades used in a rotation blade rheometer rather than a single blade.

Small variations of viscosity in a given flow medium whose viscosity is being measured can cause variations in flexing of a blade, while the flow medium is rotating.

Embodiments of the invention optionally measure various physical parameters related to blade flexibility, including one or more of: blade flex (optionally as determined by blade shape and/or distortion); blade strain; and deflection of the blade, optionally the blade tip, from a shape of an undistorted blade shape.

In some embodiments blade flex is measured optically, optionally by imaging and optionally by analyzing the image.

In some embodiments various physical parameters related to viscosity are measured, optionally including one or more of: torque required to rotate the blade; torque required to accelerate the blade; and rotational speed of the blade.

Various embodiments of the invention measure various physical parameters related to viscosity, including one or more of: shear of the medium whose viscosity is being measured; shear at a blade tip; shear near the blade surface; and shear near a surface of a container in which the blade rotates.

In some embodiments shear is measured by analyzing a flow velocity field of the medium.

In some embodiments flow of the medium is measured optically, optionally by imaging.

The flow of the medium whose viscosity is measured is taken to correspond to its velocity field.

In some embodiments flow is measured optically using one of a variety of imaging flow measurements as are known in the art. Some non-limiting examples include: image processing algorithms which are applied to a single image; to a pair of images; and/or to a set of images, acquired by an imaging system.

Some non-limiting example algorithms used to quantify flow from image(s) include: optical flow; tracking; and template matching. Some non-limiting examples of template matching include: auto-correlation; direct cross correlation; Fourier transform cross correlation; and minimum quadratic difference.

A general field of useful algorithms is the field of Imaging Velocimetry, as flow is quantified by velocity. A more particular field is optionally Particle Image Velocimetry (PIV).

Various embodiments of the invention include a computation unit configured to accept input of one or more physical parameters, including the above-mentioned physical parameters, and produce output of a viscosity measurement.

In some embodiments the computation unit includes a Look Up Table (LUT).

In some embodiments the computation unit uses only the LUT to convert the above-mentioned physical parameters, and produce output of a viscosity measurement.

In some embodiments the computation unit calculates viscosity based on equations, and/or an analytical model, and/or a semi-analytical model.

In some embodiments the computation unit calculates viscosity, then further produces deviations from an initial value based on the calculation by using a LUT.

In some embodiments the computation produces various measures, such as viscosity change with shear magnitude, and/or viscosity change with the shear history.

Various embodiments of the invention include additional inputs for the computation unit, such, by way of a non-limiting example: what medium (fluid/gas/mixture/multi-phase) is being measured; what the medium height is in the container in which the blade is configured to rotate; an approximation of an initial value of dilution of a second material within the medium; a blade identifier corresponding to a specific blade geometry; data describing blade geometry; one or more parameters describing blade thickness; blade Young modulus; and container geometry.

In some embodiments, deflection of the blade is measured by measuring blade strain, for example by measuring with a strain gauge.

In some embodiments, blade flexing is measured by measuring deflection of the blade tip from a flat blade, or from the blade's non-deformed shape, or from the blade's non-rotating shape, for example by imaging the blade and analyzing an image of the blade.

In some embodiments, torque required to rotate the blade is measured, and/or torque required to accelerate the blade; and/or rotational speed of the blade, optionally by measuring the above parameters at a rotational shaft which is connected to the flexible blade and which rotates the flexible blade.

In some embodiments, shear is measured by analyzing images (such as video images and/or still images) of the flow velocity field of the medium.

In some embodiments, the computation unit provides output of deviations from ideal-case, or modeled, solutions, and the deviations are used to calculate viscosity measurements.

In some embodiments, the computation unit provides output of deviations from viscosity as calculated by a semi-analytical model, and the deviations are used to calculate improved viscosity measurements.

A more detailed description of some embodiments of the invention is now provided:

### DESCRIPTION OF SOME EMBODIMENTS OF THE INVENTION

The present invention, in some embodiments thereof, addresses an intrinsic difficulty of measuring variations of torque in a rotational rheometer in dilute and very dilute solutions of polymers, that cause only minor alteration of friction on the liquid-solid boundaries in the device. The embodiments are an extension to the low-cost off-the-shelf rotational blade rheometer.

A standard rotational rheometer uses fixed and rigid blades, which rotate against a fluid.

Some embodiments of the invention replace the rigid and fixed blades with flexible blades of suitable structural and geometrical properties (size, thickness, Young modulus, etc.). A liquid under investigation is set in motion by the flexible blade(s) of the rotational rheometer. Torque is optionally measured on a rotating shaft driven by a DC motor with a feedback-angular-velocity control (measured via standard voltage-current or strain-gauge method).

As the blades rotates a torque transducer measures changes in strain or deflection of the flexible blade.

In some embodiments, the deflection during rotation is directly proportional to the sample viscosity.

One innovative principle is based on the fluid dynamics of a dilute solution and the fluid-structure interaction of a flexible blade rotating in the rheometer vessel. The fluid mechanics in the boundary layers on the surface of the vessel and on the surface of the blades are effectively “translated” into measurables: i) shear within the liquid, ii) torque on the shaft and iii) deflection of the flexible blade. Upon a proper calibration of various combinations of blades/vessels/liquids, a lookup-table for each of the combinations potentially provides an accurate estimate of viscosity in linear and non-linear manner (e.g. in shear thinning or shear thickening solutions).

Deflection of the blade is optionally measured optically (i.e. imaging, photo-detection, etc.), or by using strain gauges along the blade, or by other methods (e.g. laser line change, etc.). Furthermore, if the flow field in the vessel is visualized, then using imaging methods (e.g. particle tracking/imaging velocimetry principles), the instantaneous changes of the viscosity are obtainable in real-time.

Some facets of the invention are in the field of liquid properties (rheology, viscosity) measurements. Specifically, in some embodiments, the rheometer measures viscosity of very dilute solutions with high accuracy and in a cost-effective and simple way. A principle guiding some embodiments of the rheometer is measuring an interaction between the fluid and the flexible blade, which is forced to rotate, optionally at a constant or at a variable speed in a vessel with dilute solution. The properties of the flow developed in a vessel are usually not solvable analytically, as they depend on a strong coupling between boundary layers on the sides of the vessel and a boundary layer developed on the blade itself. A combined effect of the couplings depends on shear-strain properties of the measured liquid, which are potentially an output of measurement, and on known properties of the mechanical system: mechanical and structural properties of the flexible blades, rotational speed, torque on the shaft and the position of the blade in the vessel (e.g. gap to the bottom and side walls).

The operation of the rheometer optionally includes a pre-calibration using liquid samples having a known viscosity. The parameters measured during the calibration are optionally stored in a look-up table (LUT), enabling fast experimental assessment on a sample during measurement. The LUT includes data which includes measured parameters such as: i) the torque measured using strain-gauge or voltage/current measurements, optionally through a DC motor, ii) rotational speed, iii) deflection and strain of the flexible blade.

The LUT is optionally built in conjunction with a semi-analytical model solved numerically in conjunction with the experimental results. Deviations from an ideal-case solution provide calibration parameters related to mechanical losses in a given apparatus, undesired high order fluid-structure interaction modes, etc. The semi-analytical model is optionally solved in real-time synchronously with the experiment to provide the user the real-time strain-stress curve of the liquid under test.

In some embodiments a flow velocity field is measured—the shape of the boundary levels at the side walls and on the flexible blade, which potentially provides a shear-thickening or a shear-thinning behavior of the material, potentially requiring fewer measurement runs, rather than in repetitive measurements at different rotational speeds.

Cost-Effectiveness

Some embodiments of the present invention solve the intrinsic difficulty of measuring small changes of torque in the rheometer caused by minute amounts of polymers that slightly modify the friction on the liquid-solid boundary.

Some embodiments are an extension to a low-cost off-the-shelf rotational blade rheometer. Standard fixed and rigid blades of a standard rheometer are optionally replaced by flexible blades with known structural and geometrical properties. A liquid under the test is urged into rotational motion by the flexible blade rheometer. Torque, optionally measured by a standard voltage-current or strain-gauge method, is optionally measured on a rotating shaft, optionally driven by a DC motor with a feedback-angular-velocity control.

In some embodiments, a guiding principle is the fluid dynamics in the vessel filled with a dilute solution and the fluid-structure interaction of a flexible blade in rotational motion. Boundary layers on the surface of the vessel and on the two sides of each blade affect physical parameters such as: i) shear in the liquid, ii) torque on the shaft and iii) deflection of the flexible blade. Upon calibration of various blade/vessel/liquid combinations, a lookup-table of the physical parameters provides an estimate of viscosity.

In some embodiments, deflection of the blade is optionally measured either optically (imaging) or by using strain-gauges along the blade, or by other methods (e.g. direction of a laser beam, etc.) Furthermore, if a flow field in the vessel is measured using imaging methods (e.g. particle tracking/imaging velocimetry principles), then the non-linear changes of the shear-thinning or the shear-thickening solutions are obtainable.

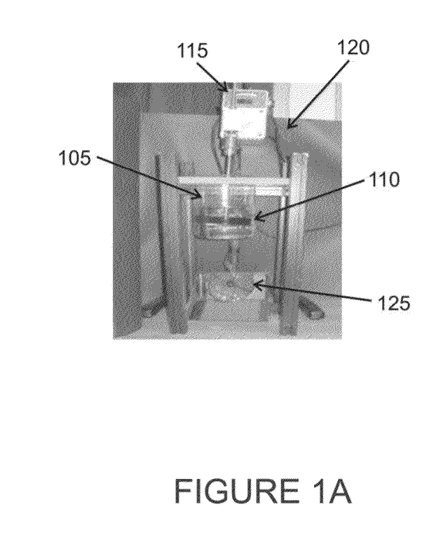

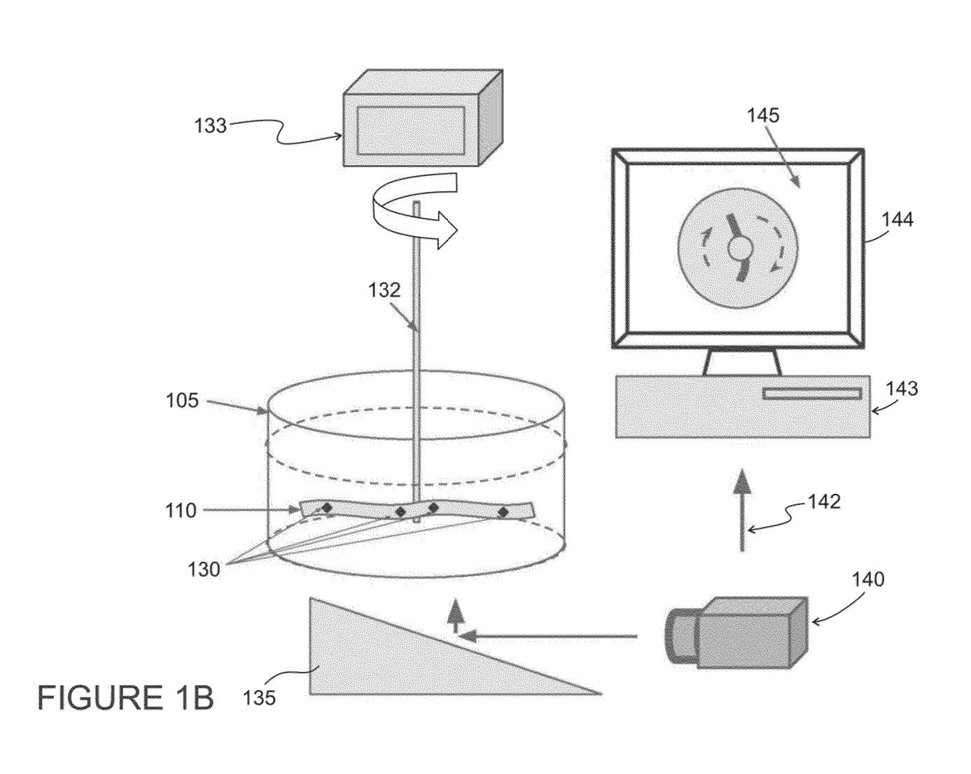

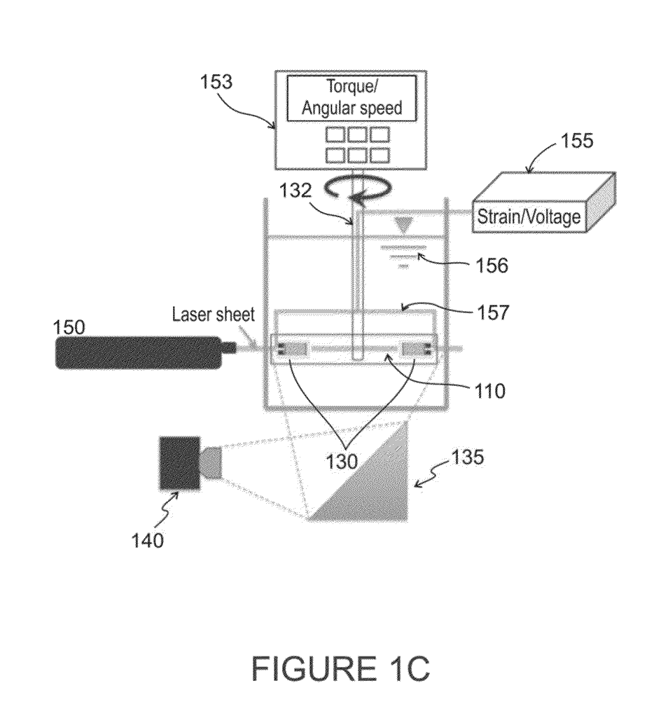

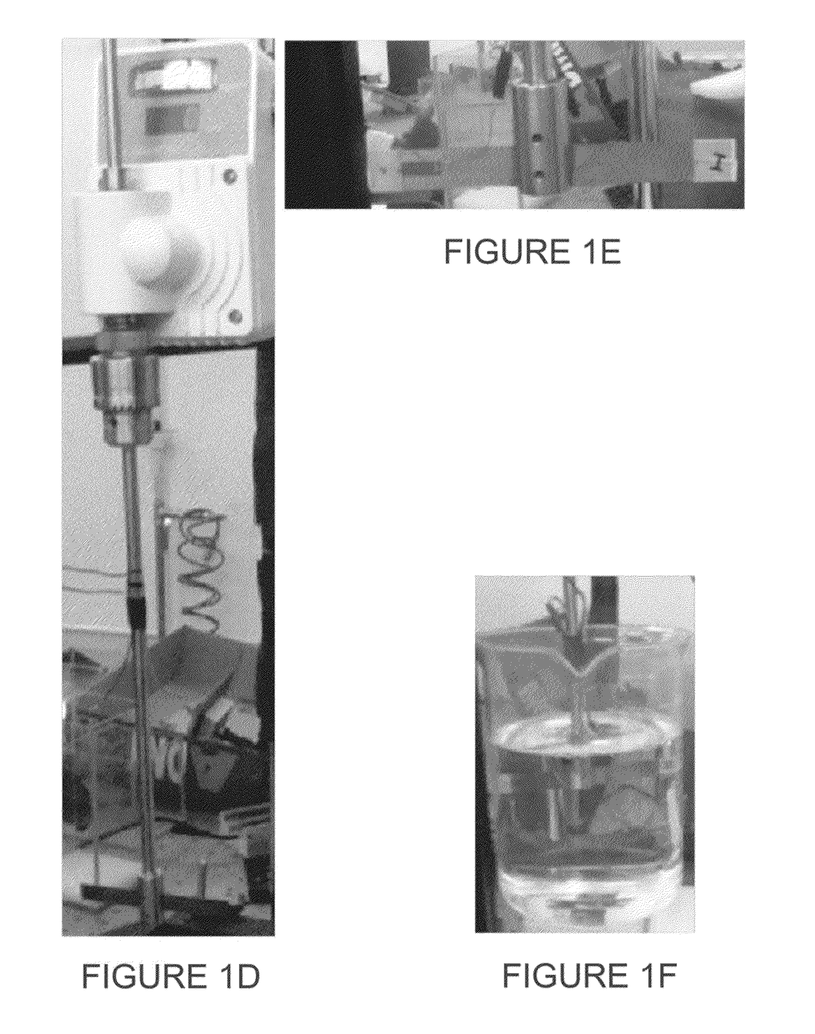

Reference is now made to FIG. 1A, which is a photo of a flexible blade rheometer constructed according to an example embodiment of the invention.

FIG. 1A depicts a part 120 of a setup used as a calibration unit to define parameters for a particle image velocimetry system including a rotational flexible blade rheometer.

The part 120 of the setup includes a motor 115, providing rotation to a flexible blade 110, rotating a fluid in a container 105, and a mirror 125 and a mirror 125 for viewing the blade and fluid through a bottom of the container 105.

The example embodiment of FIG. 1A is equipped with flexible copper blades 110 having dimensions of 50×10×0.2 mm, free-end clamped to a rotational shaft.

Reference is now made to FIG. 1B, which is a simplified illustration of a flexible blade rheometer constructed according to an example embodiment of the invention.

FIG. 1B depicts a motor 133 optionally having a built-in strain-gauge meter, optionally measuring strain by a voltage/current meter; a shaft 132 connected to the motor 133, for providing rotation to two flexible blades 110, having strain gauges 130 affixed or built into the flexible blades 110, and electrically connected to the strain-gauge meter; a container 105 for the fluid; a mirror 135 for an imager 140, such as a camera; the imager 140 optionally functionally connected 142 to a computing unit 143 having a display 144.

In some embodiments the computing unit 143 uses the display 144 to display an image 145, or a real-time display, of the rotating blades.

In some embodiments the computing unit 143 uses the display 144 to display results of calculations, such as a flow field of the fluid, and/or as a user interface to the system.

Reference is now made to FIG. 1C, which is a simplified illustration of a flexible blade rheometer constructed according to an example embodiment of the invention.

FIG. 1C depicts a motor 153 having a torque/angular speed display; a shaft 132 connected to the motor 153, for providing rotation to two flexible blades 110, having strain gauges 130 affixed or built into the flexible blades 110; a strain/voltage meter 155 electrically connected 156 157 to the strain gauges 130; a mirror 135 for an imager 140; and a laser 150 (optionally a pulsed laser, optionally dual-pulsed) for illuminating the blades and the fluid.

In some embodiments, the rheometer measures strain in the blades 110, and optionally measures angular speed and/or torque, and determines viscosity without using the imager 140.

Reference is now made to FIGS. 1D, 1E and 1F, which are photographs of components of a flexible blade rheometer constructed according to an example embodiment of the invention.

FIG. 1D depicts the motor, the torque/angular speed display, and the shaft.

FIG. 1E depicts the blades and strain gauges attached to the blades.

FIG. 1F depicts the shaft and the blades immersed in fluid inside a vessel.

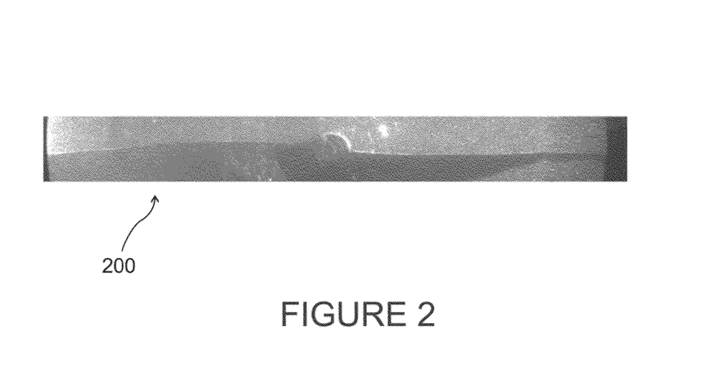

Reference is now made to FIG. 2, which is a bottom-up photograph of a flexible blade of the flexible blade rheometer constructed according to an example embodiment of the invention.

FIG. 2 depicts the flexible blade rheometer in liquid, seeded with small tracer particles and illuminated by a plane, or sheet, of laser light. FIG. 2 depicts a single image of the flexible blade, which can optionally be analyzed for blade flex, as described above. In fact, FIG. 2 depicts the blades as they are bent by the fluid.

FIG. 2 depicts an example embodiment producing an image which may optionally be analyzed, optionally as part of a sequence of images, to measure flow, especially when seeded with the tracer particles.

The set-up of FIG. 2 includes a stirrer (E-20RTM, Hsiangtai Machinery, China), in which the angular velocity can be set for a rotating shaft. On the end of the shaft two flexible thin blades made of aluminum foil have been attached.

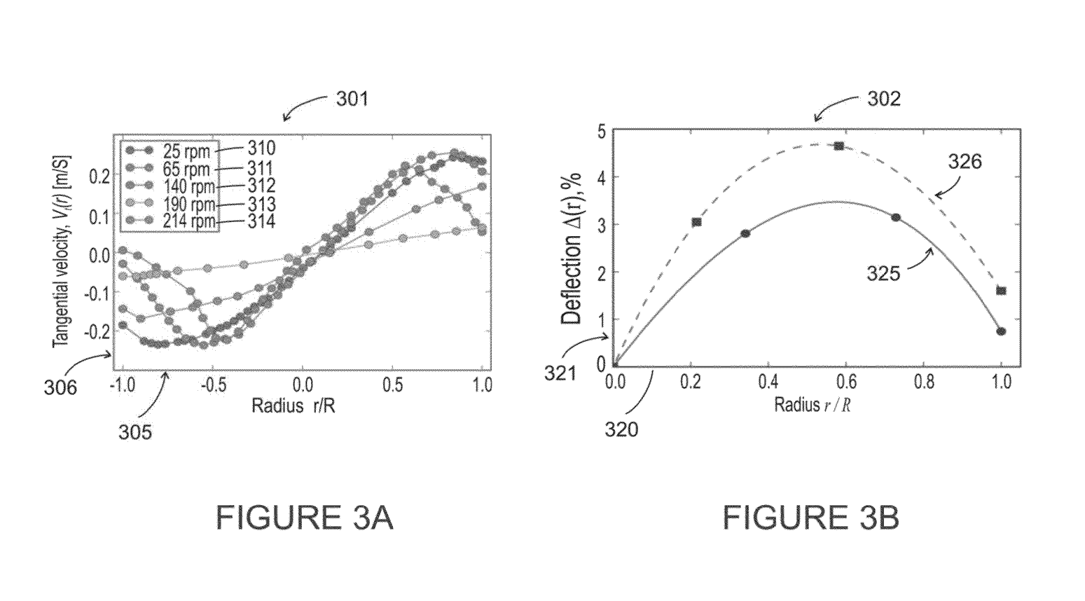

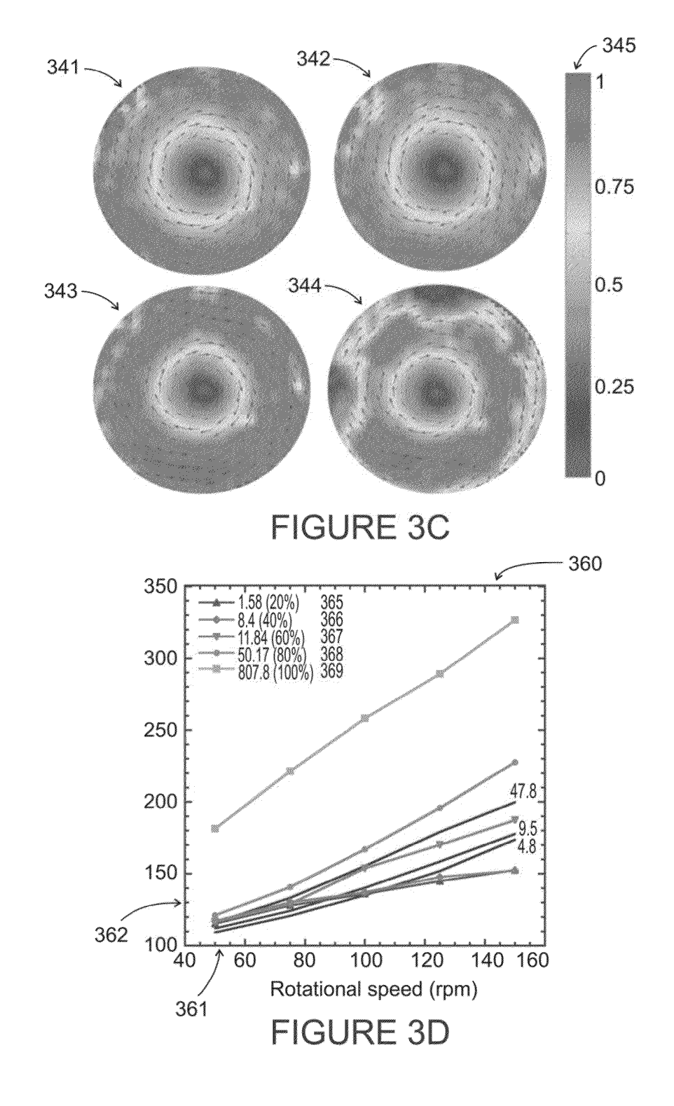

The set-up of FIG. 2 has been used in two modes: a first mode reveals the flow field around the blades, as will be described further below with reference to FIG. 3C; and a second mode to measure blade flexing in response to the flow of different liquids.

The first mode uses a laser 150 and imager 140 setup for particle image velocimetry (PIV), observing the liquid velocity field around the blades.

The second mode uses strain gauges 130 connected to the blades 110 to measure the blades flexing in response to different fluids and angular rotational rates.

In some embodiments the rheometer is fitted only with the strain gauges, used to obtain the flexing displacement.

In experiments, using some embodiments, the blades were imaged during rotation, and small blade deflections were observed, resulting in blade flexing. Optionally a linear approximation of a simple clamped cantilever describes the flexing.

In some embodiments, the velocity fields and the blade shape are obtained, the laser-imager system to verify small deflections, prior to strain-gauge measurements.

Strain Gauge Measurements

When stirring fluids with different viscosity, the flexible blades flex differently due to viscous resistance. The amount of flexing can potentially affect the rheometer's sensitivity.

During experimentation with some embodiments, strain was measured using strain gauge, gauge constant GF=2.075, attached to each of the flexible blades. The strain gauges of the embodiments were small measuring grids made of a thin conductive metal. Upon deflection of a blade, the measuring grid stretches or compresses, changing its electric resistance. The strain gauges on the blades were connected to a strain indicator (P3500, Vishay Micro-Measurements Inc., USA) using rotating electrical connections (Mercotac Inc., USA). Voltage values of the strain indicator were optionally recorded at 1000 Hz. Strain measurements were optionally taken as an average of readings from two blades (on either side of the shaft).

Table 1 below describes condition under which the above experimentation was performed:

TABLE 1

| Magnitude | | Parameter |
|---|---|---|
| 51 | mm | Blade length |
| 12 | mm | Blade width |
| 0.1 | mm | Blade thickness |
| 50 × 10⁹ | Pa | Blade Young's modulus |
| 12 | mm | Distance between |
| | | blade end and vessel |
| 34.5 | mm | Strain gauge |
| | | distance from stirrer |
| | | shaft |

A modified Wheatstone bridge electrical circuit was optionally used to measure changes in strain on the gauges, with a bypass providing high accuracy.

In some embodiments of the invention, the strain indicator optionally measures voltage values; therefore a strain-to-voltage calibration is optionally performed to obtain measurements in arbitrary strain and/or micro-strain units.

FIG. 3D, which is described in more detail further below, depicts a variation of voltage recorded by the strain gauge upon changing the strain of the flexible blade. As the strain increases the voltage increases linearly. Positive and negative values of changes of the strain indicate that the blade is flexing equally in two directions. Calibration provided the following strain-voltage conversion value: ε=3174.5×v+3.27, with an r²=0.9999, which was used to convert measurements. A non-zero value of strain under zero voltage was measured as a result of background noise.

Reference is now made to FIG. 3A, which is a graphic illustration of tangential velocity distributions of flow along a radius of a flexible blade of a flexible blade rheometer constructed according to an example embodiment of the invention.

FIG. 3A depicts a graph 301 having an X-axis 305 using units of relative radius, r/R, or distance from a center of rotation of a rotating blade divided by a maximum radius of the blade, and a Y-axis using units of meters per second to depict tangential velocity of fluid flow.

FIG. 3A depicts five example fluid flow distributions 310 311 312 313 314 obtained by PIV measurements at different rotational velocities. FIG. 310 depicts a fluid flow distribution made at a rotational rate of 25 revolutions per minute (RPM). FIG. 311 depicts a fluid flow distribution made at a rotational rate of 65 RPM. FIG. 312 depicts a fluid flow distribution made at a rotational rate of 140 RPM. FIG. 313 depicts a fluid flow distribution made at a rotational rate of 190 RPM. FIG. 314 depicts a fluid flow distribution made at a rotational rate of 214 RPM.

Reference is now made to FIG. 3B, which is a graphical illustration of a solution of a semi-analytical model of deflection of a flexible blade of a flexible blade rheometer constructed according to an example embodiment of the invention.

FIG. 3B depicts a graph 302 having an X-axis 320 using units relative radius, r/R, or distance from a center of rotation of a rotating blade divided by a maximum radius of the blade, and a Y-axis using units of percent to depict normalized deflection of a blade. Deflection is normalized by a constant length scale, in the example of FIG. 3B by a length of the blade. Deflection may also be scaled, for example, by a radius of the vessel.

FIG. 3B also depicts a line 326 showing sensitivity of the blade deflection to the mixture of water and polymer that was used.

FIG. 3B also depicts a line 325 which shows blade deflection in water, which represent a Newtonian reference.

Blade flex depicted in FIG. 3B was measured optically by imaging the blade, similarly to a method described above with reference to FIG. 2.

In some embodiments, using the graph of FIG. 3B for calibration of actual deflection in relation to expected, modeled, deflection, the corrected model is capable of a real-time viscosity estimate, synchronized with rheometer measurements of torque and blade deflection. The semi-analytical model optionally calculates deflection, or flex, of the flexible blade.

Demonstrated below are measurements performed by embodiments using Newtonian liquids with different viscosities to demonstrate sensitivity and response under varying shear rates, and blade rotational speeds. In addition, images of flow fields around the blades showing rotational speed effects and laminar limits are provided.

Reference is now made to FIG. 3C, which is a graphical illustration of two-dimensional velocity fields in a vessel at four rotational rates of a flexible blade rheometer constructed according to an example embodiment of the invention.

FIG. 3C depicts four velocity fields 341 342 343 344, which are averaged two-dimensional velocity fields showing uᵣ, and u_{θ} as functions of r and θ.

FIG. 3C depicts a two-dimensional velocity field 341 measured at a rotational rate of 63 rpm; a two-dimensional velocity field 342 measured at a rotational rate of 91 rpm; a two-dimensional velocity field 343 measured at a rotational rate of 140 rpm; and a two-dimensional velocity field 344 measured at a rotational rate of 189 rpm.

FIG. 3C also depicts a scale 345 showing velocity on a scale of 0 to 1, relative to a maximum velocity at each of the four rotational rates.

FIG. 3C depicts velocity fields of a flow in a vessel driven by a flexible blade. The flow field is obtained in the cross section of the vessel made at the height of the blade. Arrows indicate direction of the flow field, and color defines a magnitude of the tangential velocity. Velocity is depicted in a scale of 0 to 1 by normalizing with ωR, where ω is an angular velocity and R is a radius of the vessel, equal to 65 mm in the example embodiment of FIG. 3C.

In some embodiments of the invention, having a shear measurement above a certain threshold value optionally causes the rheometer to refrain from producing output of determined viscosity, or to alert a user that the determined viscosity may be suspect.

In some embodiments of the invention, having a shear measurement above a certain threshold value at specific locations in the flow field, such a next to a blade, optionally causes the rheometer to refrain from producing output of determined viscosity, or to alert a user that the determined viscosity may be suspect.

Particle Image Velocimetry (PIV)

Determining the flow field around the blades for FIG. 3C was performed using PIV measurements. A dual Nd:YAG laser (NewWave Solo 120 mJ/pulse) illuminated a two-dimensional cross-section plane of the flow in which particles 10 micrometers in diameter were seeded. Every 0.5 a second a pair of images was taken of particle locations, using a CCD camera (4008×2672 pixels, 12 bit). A relative displacement of the particles was then calculated using an open source OpenPIV package, see Taylor et al. (2011).

FIG. 3C depicts flow fields of a Newtonian 40% vol. glycerol in water solution.

FIG. 3C illustrates that tangential velocity distribution is non uniform in the radial direction.

At rotational speeds below 140 rpm the velocity is evenly distributed in the azimuthal direction and the radial velocity component is small, the fluid behaving similarly to a rigid body rotation. At a higher rotational speed (189 rpm), the velocity distribution is no longer similar to the rigid body rotation.

In some embodiments of the invention, in order to avoid unsteady flow effects, measurements of viscosity are limited to rotational rates less than 150 rpm.

To demonstrate sensitivity to low viscosity and small changes in viscosity, the strain response of several Newtonian liquids were evaluated using an example embodiment of the invention.

Silicon oil viscosity standards were used, as well as glycerol-water solutions. All measurements were performed at 25° C. Silicon oil viscosity standards were selected with low viscosities of μ=4.8, 9.5, and 47.8 mPa·s, from Brookfield Engineering Laboratories, Middleboro, Mass. In addition, glycerol-water solutions were produced at 20, 40, 60, 80 and 100% volume glycerol in double-distilled water. The viscosity of the glycerol-water solutions was first determined using a TA Instruments AR-G2 rheometer from New Castle, Del. Steady shear rate experiments were run using a 60 mm, 1° cone, and Newtonian viscosity was determined, as provided in Table 2 below. Note that the viscosities of the glycerol-water solutions are close to the viscosity standards, to highlight system sensitivity to the small changes in viscosity.

TABLE 2

| | | | | | |
|---|---|---|---|---|---|
| 100% | 80% | 60% | 40% | 20% | Glycerol |
| | | | | | % vol |
| 807.8 | 50.2 | 11.8 | 3.4 | 1.6 | Viscosity |
| | | | | | [mPa · s] |

Measurements in the example embodiment of the rheometer were run at a steady state, and system noise was subtracted. For each sample, a zero rotational speed measurement was obtained to determine background noise of the measurement system, and subtracted from subsequent measurements. Measurements began at each angular velocity after changes in strain had ceased, indicating steady state. At steady state, strain measurements were taken at a sampling rate of 1000 Hz for 10 seconds and the average strain values for both blades were calculated. The entire measurement took less than 30 seconds for each angular velocity, where 5 velocities in the range 50-150 rpm were chosen. Measurements of the standards were repeated three times, and measurements of the glycerol solutions were repeated five times.

Reference is now made to FIG. 3D, which is a graphical illustration of strain measured on a flexible blade rheometer constructed according to an example embodiment of the invention.

FIG. 3D depicts a graph 360 having an X-axis 361 using units of rotations per minute (RPM) to depict rotational rate, and a Y-axis using arbitrary units to depict strain of a blade.

Five lines 365 366 367 368 369 are depicted in the graph 360 of FIG. 3D, each corresponding to a different fluid, the different fluids being solutions of different proportions of glycerol in water, as described above.

Additional lines in the graph 360 depicts strain in silicone oil viscosity standards, which are depicted as lines without reference numbers, marked on the right side of the graph 360 by their viscosities 4.8, 9.5, and 47.8 (mPa·s) respectively.

Line 365 depicts strain as a function of blade rotation rate for a solution of 20% glycerol in water; line 366 depicts strain as a function of blade rotation rate for a solution of 40% glycerol in water; line 367 depicts strain as a function of blade rotation rate for a solution of 60% glycerol in water; line 368 depicts strain as a function of blade rotation rate for a solution of 80% glycerol in water; and line 369 depicts strain as a function of blade rotation rate for a solution of 100% glycerol.

FIG. 3D illustrates that strain is proportional to viscosity and is nearly linear with rotation rate.

The silicon oil viscosity standards were used for calibration and to compare the measured response of the glycerol-water solutions to the viscosity standards. The viscosity of the glycerol-water solutions was also independently measured using the high accuracy shear rheometer mentioned above in order to verify the results.

FIG. 3D shows, for example, that the 80% glycerol solution is above the curve of the silicon oil viscosity standard of 47.8 mPa·s, as expected from the rheometer measurements (Table 2). We also note that the embodiment used to produce the graph 360 of FIG. 3D differentiates between samples with similar viscosities in a range close to water viscosity, such a between 20% and 40%.

In all the samples, when rotational speed is increased so does the deformation of the blades. The increase appears close to linear, yet appears convex in some of the samples. In general, we observe a higher deformation for higher viscosity standards and sample liquids. The increased deformation indicates a stronger shear stress applied by the liquid samples. In Newtonian liquids, the stress is proportional to the viscosity, and thus increased strain on the blades indicates an increase in the viscosity.

Some Exemplary Features and Potential Advantages

Viscometry of dilute solutions is a difficult task, which to date required high precision mechanics, electronics and/or optics. Existing solutions are expensive. Some embodiments of the proposed invention utilize fluid-mechanic principles of the fluid-structure interaction which provides a potential work-around for measuring small changes of viscosity. Small viscosity changes are potentially amplified by interaction of thin boundary layers on sidewalls of a vessel, by high shear in the small gap between the wall and the blade, and on the rotating flexible blade itself.

### Additional Embodiments of the Invention

Example embodiments of the invention are used not only in viscosity measurements, but also in measuring other rheological properties of Newtonian and non-Newtonian liquids, in gases, and in viscous solutions such as liquid metals, and so on.

Non-Newtonian liquids are optionally measured using the flexible blade rheometer in conjunction with imaging methods—the flow field provides a shear distribution of the fluid under test, optionally directing to an appropriate LUT, and flex of the blade optionally providing a value to be looked up in the table.

Some fluids change behavior according to a history of applied shear and/or to a distribution of the applied shear.

In some embodiments the shear applied to the fluid is known and/or controlled, for example by increasing a flow rate in a pipeline, and/or alternatively changing a rotation speed of the blades such to control the shear level of the material.

In some embodiments the rotation is optionally increased and/or optionally decreased, in order to test sensitivity of the fluid to changes in the shear rate.

In some embodiments, for example embodiments used to measure very viscous materials, thicker and shorter flexible blades are used.

In some embodiments, a viscosity measurement is optionally performed at increasing rotational speed of the blades, measuring a rate of change of the deflection (flex) of a blade, optionally in addition to a maximum value of deflection.

In some embodiments, such as measuring viscosity of liquid metal solutions, anticorrosive coatings are optionally applied to the blade and/or to the strain gauges, and/or the strain gauges are optionally embedded in the blade material.

In some embodiments there are optional extensions related to the frequency measurements of unstable modes of the rotating blades, and/or related to time-dependent changes in the material, which are required in continuous process engineering devices. The principle can be used also in two- or multi-phase liquids, i.e. in presence of solids, gas-liquid mixtures, oil-gas-solid fractions, and similar. Time-dependent operation of the rheometer (e.g. step or impulse functions, square waves) can be used to measure instantaneously the different modes of processes with change of phase (solidification, melting).

### Example Embodiment 1

### Providing real time monitoring of flowing material—using a liquid level control in a pre-calibrated vessel, alerting of minute changes of viscosity. Some example applications:

a) process control in industry

b) hazard/content control in water treatment

c) water safety/security applications

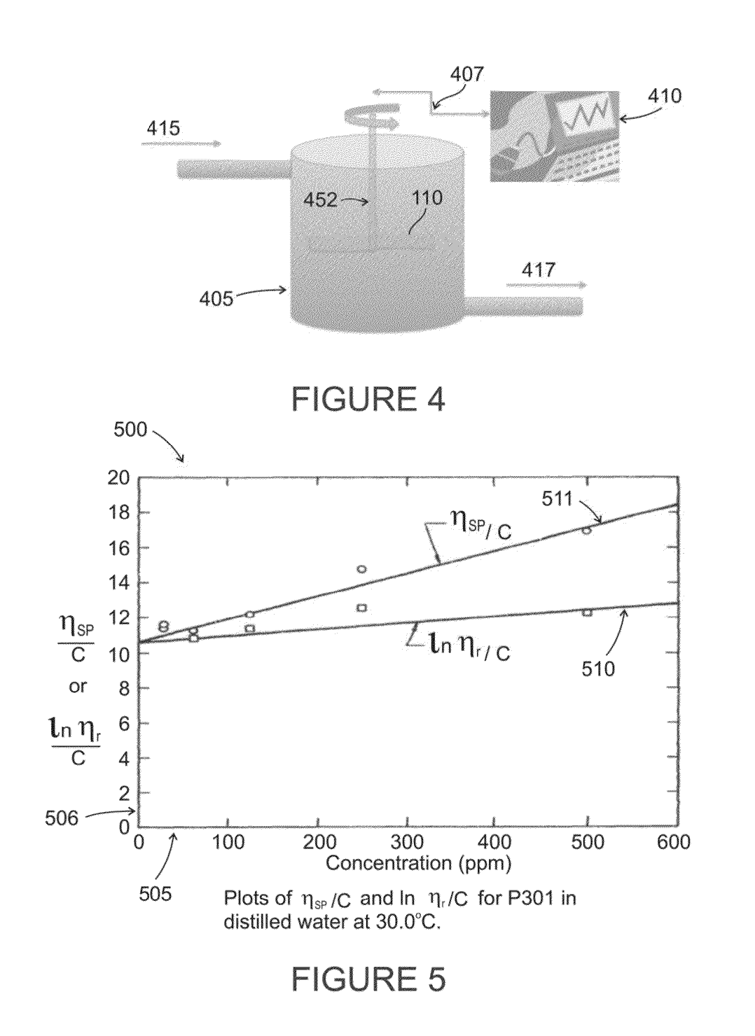

Reference is now made to FIG. 4, which is a simplified illustration of a real time monitoring device based on the flexible blade rheometer.

FIG. 4 depicts a vessel 405 into which fluid flows 415 from the left, and exits 417 from the right. A shaft 452 with flexible blades 110, as described above with reference to other embodiments such as depicted in FIGS. 1A-1F and 2, is rotated in the vessel 405. Data corresponding to physical parameters such as blade flex and speed of rotation is sent 407 to a computing unit 410, which determines viscosity of the fluid.

The embodiment of FIG. 4 can serve as an in-line measurement of viscosity.

In some embodiments, the rheometer can, for example, be connected in-line to an industrial processing line for quality control. On that line, fluid can be optionally diverted to the rheometer, and viscosity optionally determined within seconds. The fluid can also be returned to the batch. That can potentially remove a need for sampling fluid and offline measurement, and can potentially provide continuous real-time data.

The cases described above under the titles “Flowing a fluid past a fixed blade” and “In-line measurement VS sample measurement” potentially describe the example embodiment of FIG. 4.

Experimental Results Pertaining to Viscosity

Viscosity of dilute polymer solutions of poly(ethylene oxide) Polyox WSR 301 were used to demonstrate the concept of the flexible blade rheometer. The formula of the given polymer is —[CH₂—CH₂—O]—ₙ, Molecular weight of this polymer is 4×10⁶. Viscosity of dilute polymer solutions of Polyox WSR 301 changes with concentration.

A few examples of experimental results published by independent groups of research are given below. The notation η_{SP} is used for specific viscosity (dimensionless), c is used for polymer concentration (gram/deciliter), their ratio η_{SP}/c is used for reduced viscosity (optionally using units of deciliters/gram), and ηᵣ is used for relative viscosity. These quantities are used in the definition of the intrinsic viscosity:

$$[ η ] = {lim}_{\{ c \to 0 \}} \frac{\{ η - {η}_{s} \}}{{c η}_{s}} = {lim}_{\{ c \to 0 \}} \frac{{η}_{sp}}{c}$$

Where η stands for a solution viscosity and ηₛ stands for a solvent viscosity (i.e. water).

Experimental results are shown in FIG. 5.

Reference is now made to FIG. 5, which is a graphical representation presented in “Dilute Solution Properties of Drag Reducing Polymers, by Sylvester N. D. and Tyler, J. S. Technical report THEMIS-UND-70-8, University of Notre Dame, 1970”.

FIG. 5 depicts a graph 500 with an X-axis 505 using units of parts per million (ppm) representing concentration of Polyox WSR 301 in distilled water at 30.0° C.; and a Y-axis 506 using dimensionless units representing η_{SP}/c and lnηᵣ/c, for line 511 and line 510 respectively.

FIG. 5 illustrates that viscosity of the solution measured is, in some cases, independent of shear rate, which may vary in a flexible blade rheometer in different regions of the flow and/or against different regions of the blade.

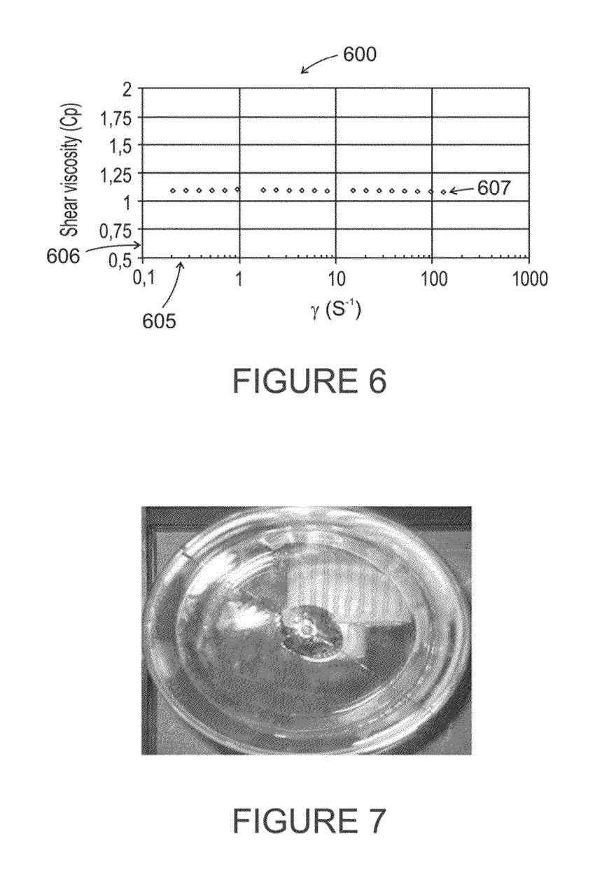

Reference is now made to FIG. 6, which is a graphical representation of shear viscosity measurements of the drag-reducing solution of 30 wppm polymer polyox, presented in “Cadot, Bonn, Douady, Phys. Fluids 10(5), 426-436, 1998.

FIG. 6 depicts a graph 600, with a logarithmic X-axis 605 using units of [seconds⁻¹] representing shear rate y; and a Y-axis 606 using units of centipose [Cp] representing viscosity.

FIG. 6 depicts experimental results of measuring a drag-reducing solution of 30 weight ppm (wppm) polymer polyox (WSR 301).

FIG. 6 depicts that an addition of 30 ppm of a polymer which reduces drag (for example in pipelines of water, oil and other liquids) hardly changes viscosity over a broad range of shear rates.

FIG. 6 is intended to demonstrate that standard viscometers using a measurement of shear potentially need to measure a very small change over very large ranges of shear. FIG. 6 illustrates a fluid which shows very weak dependence of viscosity on shear rate. Shear-based rheometers or viscometers are typically not sensitive enough to detect the small change.

FIG. 5 illustrates a potential linear relation between concentration of a polymer in distilled water, and shows that different concentrations have different viscosity. FIG. 6 illustrates that the different concentrations, which change shear of the fluid, may potentially cause very small changes in shear measurements, and so potentially make it hard to measure viscosity via shear measurements.

Referring again to FIG. 3D, which measures viscosity using an example embodiment of the invention, FIG. 3D demonstrates a relatively large change between the lines 365, 366, 367, 368 and 369, each of which represents a fluid with different viscosity.

Reference is now made to FIG. 7, which is a bottom view of the flexible blade rheometer (static). The blade is 0.05 mm thick, 20 mm wide flat plate made of aluminum.

FIG. 7 is yet another example of an image of the flexible blade rheometer, which can optionally be analyzed for blade flex, as described above with reference to FIG. 2, and also an example of a type of image which may be analyzed, optionally as part of a sequence of images, to measure flow, as described above with reference to FIG. 2.

In various embodiments the blade is optionally made of metal or a similar material which has a known Young modulus and Poisson's ratio. Material, thickness, width and length of the blade are optionally selected so as to potentially increase a static sensitivity of the instrument, that is, providing a larger linear deflection in order to yield better resolution inn viscosity measurement.

In some embodiments, blades are selected to have a Young's modulus and size to providing a desired sensitivity and precision.

In some embodiments, multi-material flexible blades are used in order to obtain two or three flexing curves which can potentially increase the rheometer's accuracy.

Various embodiments are equipped with calibration curves for various sets of blade-liquid combinations.

In some embodiments, models using finite element software are optionally deployed.

Various results were presented herein which were performed under conditions of steady shear, or steady rotational rate.

In some embodiments blade flex, and therefore viscosity measurements, are optionally performed while shear and/or rotational rate are being changed, optionally revealing dynamic rheology of the fluid.

In some embodiments, the shear and/or rotational rate are changed periodically, so as to oscillate, optionally revealing dynamic rheology of the fluid.

An Example Embodiment Method

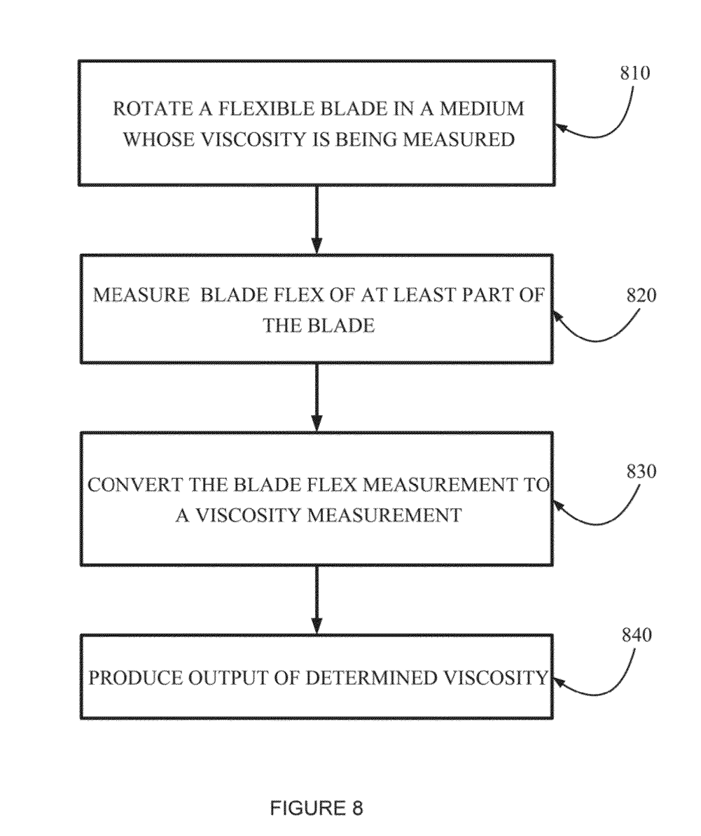

Reference is now made to FIG. 8, which is a simplified flow chart illustration of a method for measuring viscosity according to an example embodiment of the invention.

The method of FIG. 8 includes:

rotating a flexible blade in a medium whose viscosity is being measured (810);

measuring blade flex of at least part of the blade (820);

converting the blade flex measurement to a viscosity measurement (830); and

producing output of determined viscosity (840).

It is expected that during the life of a patent maturing from this application many relevant strain gauges will be developed and the scope of the term strain gauge is intended to include all such new technologies a priori.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A rheometer comprising:
a flexible blade;
a unit for measuring flex of at least part of the blade;
a computation unit configured for converting input of parameters from the measurement unit to output of viscosity measurement.

2. The rheometer of claim 1 and further comprising an imaging measurement unit, positioned to image the blade-medium interaction, at least some of the time, wherein the computation unit is also configured to use input from the imaging measurement unit for the converting to output of viscosity measurement.

3. The rheometer of claim 2 in which the imaging unit measures blade flex.

4. The rheometer of claim 1 in which the blade flex is measured by measuring blade strain.

5. The rheometer of claim 2 in which the imaging measurement unit estimates fluid flow.

6. (canceled)

7. The rheometer of claim 1, configured to be in-line to a flow of a medium whose viscosity is to be measured.

8. The rheometer of claim 1 in which the flexible blade is attached to a rotational shaft, which rotates the flexible blade in a medium whose viscosity is being measured and further comprising one or both of:
a torque measurement unit for measuring torque exerted on the flexible blade; and
a rotational speed measurement unit for measuring rotational speed of the blade.

9-11. (canceled)

12. The rheometer of claim 1 and further comprising a shear measurement unit, the shear measurement unit measuring shear in a medium whose viscosity is being measured.

13. The rheometer of claim 1 and further comprising a unit configured to measure deflection of a tip of the blade while the blade is rotating.

14. The rheometer of claim 13 in which the unit configured to measure deflection of the tip of the blade comprises a camera for capturing images of the blade.

15-17. (canceled)

18. The rheometer of claim 1 in which the computation unit comprises a unit configured to calculate a model-based value of viscosity, and to provide deviations from the model-based value of viscosity.

19. (canceled)

20. A method for determining viscosity comprising:
rotating a flexible blade in a medium whose viscosity is being measured;
measuring blade flex of at least part of the blade;
converting the blade flex measurement to a viscosity measurement; and
producing output of determined viscosity.

21. (canceled)

22. The method of claim 20 and further comprising imaging blade flex and using input from the imaging for the producing output of determined viscosity.

23-27. (canceled)

28. The method of claim 20 in which the blade flex is measured by measuring blade strain.

29. The method of claim 20 and further comprising imaging and estimating fluid flow.

30-31. (canceled)

32. The method of claim 20 and further comprising measuring torque on a shaft rotating the flexible blade, and wherein the converting also comprises using a result of a torque measurement to produce the viscosity measurement.

33. The method of claim 20 and further comprising measuring shear and wherein the converting also comprises using a result of a shear measurement to produce the viscosity measurement.

34. (canceled)

35. The method of claim 20 and further comprising measuring shear and further comprising alerting a user that output of determined viscosity may be unreliable when a value of measured shear is higher than a threshold value.

36. (canceled)

37. The method of claim 20 and further comprising capturing an image of the blade while the blade is rotating, measuring deflection of a tip of the blade while the blade is rotating, based, at least in part, on analyzing the image, and wherein the converting also comprises using a result of the blade tip deflection measurement to produce the viscosity measurement.

38. (canceled)

39. The method of claim 20 and further comprising imaging a flow velocity field in the medium whose viscosity is being measured and using input from the imaging for the producing output of determined viscosity.

40. The method of claim 20 wherein the converting the blade flex measurement to a viscosity measurement further comprises:
using at least one physical parameter from the group which includes:
a medium identifier;
a height of the medium within a container in which the blade is configured to rotate;
an approximation of an initial value of viscosity of the medium;
an approximation of an initial value of dilution of a second material within the medium;
a blade identifier;
parameters describing the blade geometry;
one or more parameters describing blade thickness;
blade Young modulus; and
parameters describing the container geometry,
to produce the viscosity measurement.

41. The method of claim 20 in which the producing output of determined viscosity comprises producing an alert of changes of viscosity over time.

42. (canceled)

43. The method of claim 20 in which the rotating, the measuring, the converting and the producing are performed continuously.
